(19) United States
(12) Patent Application Publication
(10) Pub. No.: US 2003/0071454 A1
(43) Pub. Date: Apr. 17, 2003

(54) Home beautification journal and method for recording information relating to home beautification projects

(76) Inventors: Jay Z. Muchin, Manitowoc, WI (US); David J. Merten, Manitowoc, WI (US)

Correspondence Address: MARSHALL, GERSTEIN & BORUN, 6300 SEARS TOWER, 233 SOUTH WACKER, CHICAGO, IL, 60606-6357, US

(21) Appl. No.: 10/271,228

(22) Filed: Oct. 15, 2002

Related U.S. Application Data
(60) Provisional application No. 60/329,228, filed on Oct. 12, 2001.
(60) Provisional application No. 60/363,616, filed on Mar. 12, 2002.

(51) Int. Cl. B42D 3/00

(52) U.S. Cl. 281/31

(57) ABSTRACT

A home beautification journal has a plurality of sections including one or more pages containing fields for entering information regarding home beautification projects, a plurality of tabs, and a protective cover. Each section corresponds to a household area. Each tab also corresponds to one of the one or more household areas or household items.

A method for organizing and recording information regarding home beautification projects includes providing one or more pages containing a room field, a surface field, and a surface treatment field, recording a room identifier in the room field, recording a surface identifier in the surface field, and recording a surface treatment identifier in the surface treatment field.

### CROSS REFERENCE TO RELATED APPLICATIONS

This application claims the benefit under 35 U.S.C. § 119(e) of U.S. Provisional Application No. 60/329,228, filed Oct. 12, 2001, and U.S. Provisional Application No. 60/363,616, filed Mar. 12, 2002, the full disclosure of which, in their entirety, are hereby incorporated by reference.

### FIELD OF THE DISCLOSURE

The disclosure is generally related to project organization and planning, and more particularly to a home beautification journal and a method for recording information relating to home beautification projects.

### BACKGROUND OF THE DISCLOSURE

Home improvement projects are regularly undertaken by homeowners. One problem frequently associated with home improvement projects is the homeowner's failure to properly record and organize information relating to the products and processes used in completing the improvement projects. For example, homeowners often forget to record the specific brand, color, application method, vendor, etc. of a paint used in an improvement project. With respect to painting projects, the pertinent information is often recorded directly on the leftover paint can (on the occasions that such information is recorded), and thus may become unreadable.

Organizational planners, in general, are well-known. For example, organizational planners such as commercially available “day planners” have been used successfully by many people to navigate the organizational demands of modern life by allowing users to quickly record and access scheduling information. No similar product affords a homeowner the means to successfully navigate the organizational difficulties associated with planning and organizing home beautification projects.

### SUMMARY OF THE DISCLOSURE

According to one exemplary embodiment of the present disclosure, a home beautification journal includes a plurality of sections, each of which corresponds to a household area. The sections contain at least one page. The at least one page contains various fields for entering information regarding home beautification projects. The home beautification journal further includes a plurality of tabs, each of which corresponds to a household area, and a protective cover.

According to another exemplary embodiment of the present disclosure, a method for organizing and recording information regarding home beautification projects includes providing at least one page containing a room field, a surface field, and a surface treatment field, recording a room identifier in the room field, recording a surface identifier in the surface field, and recording a surface treatment identifier in the surface treatment field.

### BRIEF DESCRIPTION OF THE DRAWINGS

Exemplary aspects and features of a home beautification journal in accordance with the present disclosure are described and explained in greater detail below with the aid of the drawing figures in which:

FIG. 1 shows the exterior of a home beautification journal;

FIG. 2 shows the interior contents of a home beautification journal;

FIG. 3 shows two pages of a home beautification journal; and,

FIG. 4 shows the application of a paint sample to a page of a home beautification journal.

### DETAILED DESCRIPTION OF THE DISCLOSURE

The present disclosure is directed to a home beautification journal and a method for recording information relating to home beautification projects. According to one aspect of the present disclosure, the home beautification journal may be used for recording information relating to the decoration of interior and exterior surfaces and areas.

In general, a home beautification journal in accordance with the present disclosure includes a plurality of sections, a plurality of tabs, and a protective cover. The individual sections of the home beautification journal generally correspond to a household area or a household item that has been or will be the subject of home improvement efforts. The individual sections may, in accordance with a user's preferences, suitably correspond to any household area(s) or item(s). Typical household areas are, for example, the house exterior, the garage, the porch, the shed, the house interior, the kitchen, the dining room, the living room, the family room, the great room, the master bedroom, the guest bedroom, the downstairs bathroom, the master bathroom, the kids' bathroom, the utility room, the pantry, the upstairs closet, and the like. Typical household items are, for example, furniture and fixtures. As used herein, the term household area encompasses household item(s).

Alternatively, the individual sections of the home beautification journal may be adapted for use in planning and organizing improvement projects relating to manufacturing locations, offices, and business facilities.

Each individual section of the home beautification journal includes at least one page containing fields for entering information regarding home beautification projects. Typically, the fields for entering information regarding home beautification projects include information pertinent to home improvement project planning and/or execution. The at least one page may also include a page for entering information regarding wall treatments, a page for entering information regarding trim treatments, and/or a page for entering information regarding ceiling treatments.

The fields for entering information generally contain a textual designation pertaining to the information to be entered therein. Further, the fields for entering information may suitably include an area for entering additional text.

The fields may suitably designate, for example, location, paint color, paint number, paint formula, paint brand, paint vendor, date of purchase, paint cost, date painted, painter's name, number of coats, brush/bristle type, roller/nap type, container number, primer information, surface area, amount of paint anticipated/consumed, job cost, carpet name, carpet brand, carpet type, carpet color, tile name, tile brand, tile type, tile color, tile pattern, linoleum name, linoleum brand, linoleum type, linoleum pattern, wood type, wood source, wood cost, stain cost, stain name, stain brand, stain type, stain color, brick name, brick brand, brick color, plaster name, plaster brand, plaster type, plaster color, bedding name, bedding source, fixture name, fixture brand, fixture type, fixture color, fixture source, fixture cost, furniture type, furniture color, furniture cost, drapery name, drapery brand, drapery type, drapery color, drapery source, drapery cost and drapery pattern, and the like.

Additional fields for entering information may relate to special treatments. Fields for entering information relating to special treatments generally designate faux technique, faux applicator, basecoat, first glaze, second glaze, stamping information, stencil information, application details, designer notes, and the like.

The fields for entering information regarding home beautification projects may suitably comprise check box fields. In this regard, the user may be provided with a set of predetermined possibilities to facilitate and encourage accurate and timely recordation of such information. An exemplary embodiment wherein the fields for entering information comprise check boxes relates to paint type information. For example, check box fields indicating whether the paint used in completing the home improvement beautification project is flat, satin, semi-gloss, gloss, or other (which may further include a field for entering additional text) may be provided on the pages. Additional check box fields indicating whether the paint is oil-based or latex may also suitably be included. Other fields for entering information which contain a textual designation of the information to be entered therein may also be adapted for use in the check box format.

The home beautification journal further includes a plurality of tabs, each of which corresponds to a subject household area, and identifies the beginning of a particular section. In one embodiment, the tabs correspond to a household area or a household item that has been or will be the subject of home improvement efforts. The home beautification journal may include section header pages having tabs attached directly thereto. Such section header pages having tabs attached directly thereto may also include a plurality of slits configured to hold a photograph of the subject room(s) or item(s).

Exemplary tabs correspond to household areas such as exterior, kitchen, living room, bedroom, and bathroom. The tabs may be configured in a layered fashion such that direct overlap (and thus visual obstruction) does not occur.

Additionally, in some embodiments the home beautification journal may include pages having tab members attached directly thereto. Such tab members may be used to quickly access, record, and organize information regarding a specific subject household area within a specific section. For example, tab members relating to the wall treatments, the trim treatments, and/or the ceiling treatments can be used to record, access, and organize information in a specific section. Accordingly, a section of the home beautification journal may suitably include a page for entering information relating to wall treatments, a page for entering information regarding trim treatments, and/or a page for entering information regarding ceiling treatments. The tab members are preferably configured in a layered fashion such that direct overlap (and thus visual obstruction) does not occur.

Other tab members may also be used to organize, access, and record information regarding the floor, windows, the bedding, the draperies, the appliances, the countertops, fixtures and the like are also contemplated to be within the present disclosure. Tab members corresponding to the exterior may be used to organize, access, and record information pertaining to the siding, the window trim, the eaves, the roof, the shingles, the front door, the steps, the fence, the porch, the deck, the patio, the lights, the awning, the chimney, and the like.

Paint may be applied to the surface of one of the pages in order to record a visible paint sample. In the alternative, the pages may also suitably include second tab members and a coat of paint may be applied to the surface of second tab member to provide a visible paint sample. Other visual decorating information such as wallpaper swatches, tile samples, graphical representations, carpet samples, linoleum samples, and the like may also be recorded on the second tab member.

When the second tab members are configured in a layered configuration, the paint scheme or the color combinations for a specific household area is visible. Accordingly, in one embodiment, the home beautification journal allows a user to simultaneously view the visual decorating information relating to the wall treatments, the trim treatments, and/or the ceiling treatments thereby allowing a user to coordinate the decoration of a section topic (such as a room).

In the alternative, the pages of the home beautification journal may include windows or cutouts which facilitate the viewing of an underlying second tab member containing a visual paint sample or other visual decorating information.

The pages may comprise about 20 pound bond paper. However, the paper preferably comprises paper of at least about 90 pound index (and more preferably at least about 110 pound index) when it is desired to apply a paint sample directly to the paper.

The home beautification journal may also comprise a fastener element for keeping the journal in a closed position so as not to inadvertently expose the journal contents. Easily removable fastener elements such as elastic bands, slip covers, and clips are preferred.

The surface of the protective cover is resistant to damage and is generally manufactured from plastic. The cover may suitably comprise a binder having a spine and receiving rings for containing the journal contents. The cover may also further comprise at least one pocket for receiving items such as a paint brush, fabric samples, receipts, etc.

When a property that has been the documented subject of the home beautification journal is sold, a well-maintained home beautification journal provides the subsequent owner with a convenient, accurate, and facile source of information for replicating, completing, and touching-up previous home improvement efforts. Such a journal also advises the subsequent owner that the property was maintained with a great deal of care.

While the home beautification journal has generally been described in a historical organizational sense, the home beautification journal may also be used to organize and plan home improvement projects before initiating work. For example, the home beautification journal provides do-it-yourselfers with a mechanism for planning and organizing home improvement projects prior to undertaking the project by including pages containing fields for entering information relating to project planning, such as, the price of paint. In this regard, additional fields for entering information relating to project planning, such as, for example, surface area or anticipated paint amount, may suitably be included on the pages of the home beautification journal.

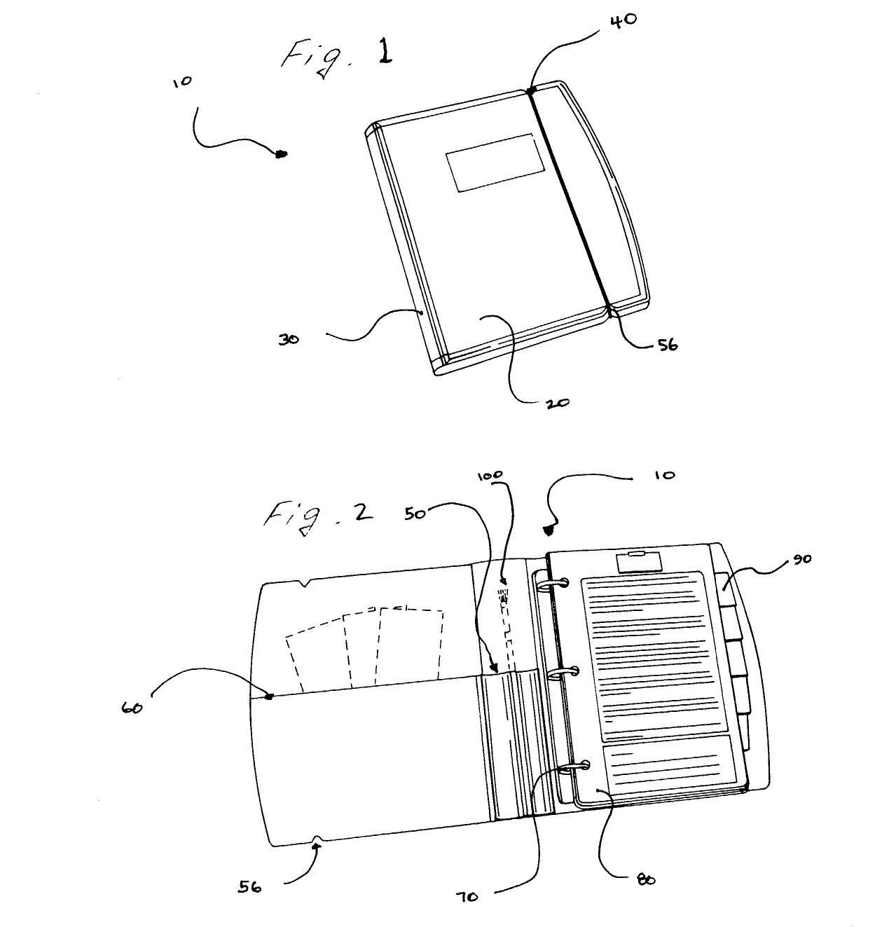

FIG. 1 shows a home beautification journal 10. The journal 10 includes a protective cover 20, which is preferably manufactured from a damage resistant material such as plastic. The journal 10 further includes a spine 30. The home beautification journal is shown in a closed position in FIG. 1. A fastener element 40 may be used to keep the journal in a closed position so as not to inadvertently expose the contents of journal 10. Notches 56 may receive a fastener 40 element and facilitate proper positioning of fastener element 40. When the journal is in an open position, fastener element 40 may be positioned across a page of the journal to function as a page marker.

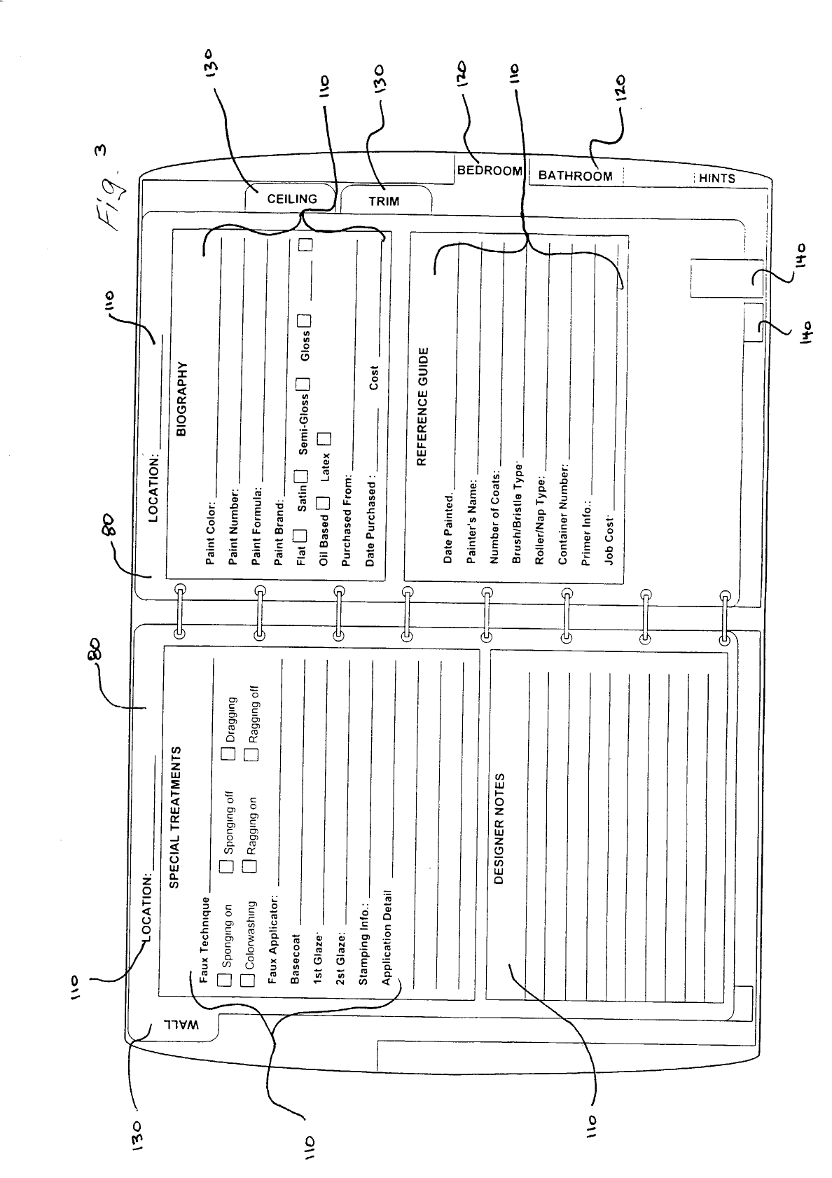

FIG. 2 shows a home beautification journal 10 in an open position that allows a user to quickly record, access, and organize information. The home beautification journal includes pocket 50 which has been adapted to receive and store a paint brush 100. Paint brush 100 may be used in conjunction with the paint journal. In one embodiment, the pocket 50 is a cloth pouch. The home beautification journal 10 may include additional pockets 60 for receiving and storing additional information and items relating to home improvement projects such as receipts, marketing literature, etc. The journal 10 also includes receiving rings 70 which are fixedly connected to spine 30 (shown in FIG. 1). The rings 70 releasably receive pages 80. Tabs 90 may be used to quickly navigate, organize, record, and store information relating to home improvement efforts.

In a preferred embodiment, the journal 10 comprises a three ring binder. Other multi-ring binders, for example, five ring binders, may also be used. Alternatively, the pages may be permanently coupled or bound to one another by spiral binding, book binding, or other conventionally known permanent binding techniques.

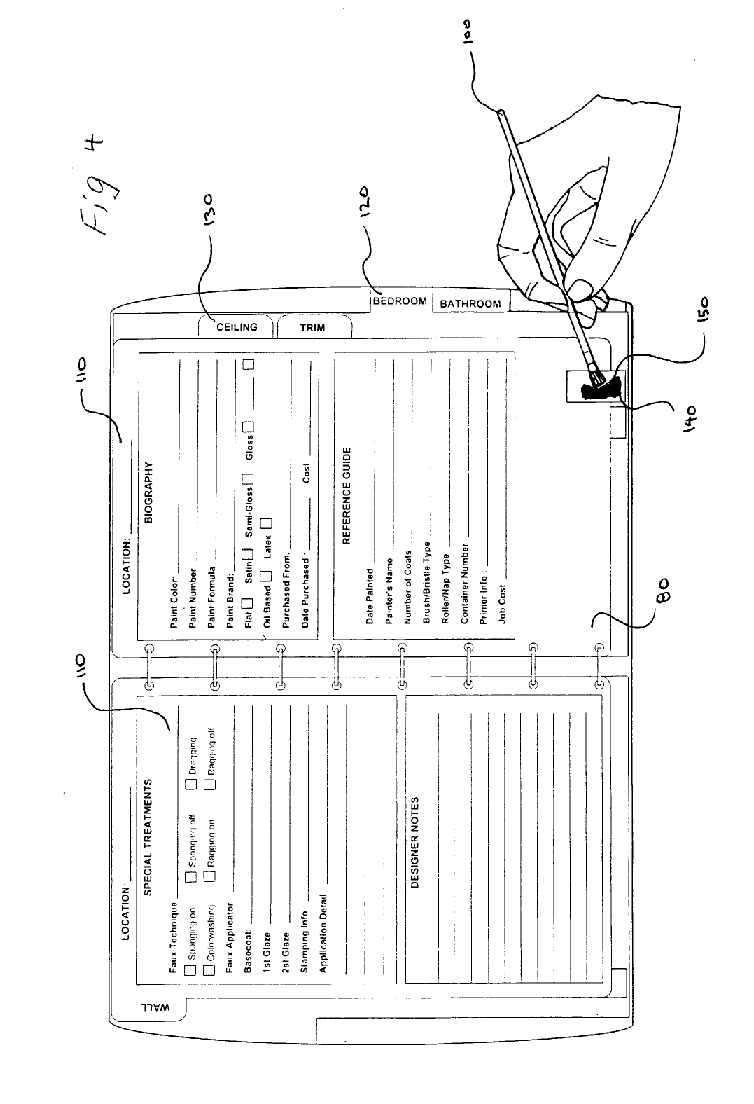

FIGS. 3 and 4 illustrate exemplary pages 80 containing fields 110 for entering information regarding home beautification projects. Generally, fields 110 include a textual designation of the information to be entered therein. Tabs 120 identify the beginning of a section of the home beautification journal and generally correspond to a household area or a household item that has been or will be the subject of home improvement efforts. For example, in the embodiment illustrated in FIGS. 3 and 4, tabs 120 correspond to a bedroom and a bathroom. An additional miscellaneous or hints tab may also suitably be included in the home beautification journal.

FIGS. 3 and 4 further depict tab members 130 which are attached directly to pages 80. Such tab members 130 may be used to further categorize and organize information relating to home improvement projects within a given tab section. For example, tab members 130 allow a user to further subdivide information relating to specified household areas or household items that have been or will be the subject of home improvement efforts. As shown in FIGS. 3 and 4, such tabs may suitably include textual designations such as wall, ceiling, and or trim. As can be seen in FIGS. 3 and 4, tab members 130 are configured in a layered fashion so that no overlap or visual obstruction occurs. Further, tab members 130 are generally located completely within tabs 120. Accordingly, the outer edge of tab member 130 is not visible for sections which are not being accessed and/or completed by a user.

As shown in FIGS. 3 and 4, second tab members 140 may be affixed to a page and a painting sample may be applied thereto. FIG. 4 illustrates the application of a coat of paint to the surface of second tab member 140 to provide a visible paint sample 150 for future reference.

Although the home beautification journal has been illustrated for use in decorating and or improving various rooms, it may also be used for recording, organizing, and accessing information relating to improving or decorating other areas such as physical locations including, but not limited to, flower gardens, area landscaping, patios, decks, building interiors, building exteriors, and the like.

For example, the home beautification journal may be utilized with respect to a flower garden so that each section of the home beautification journal corresponds to a particular area of the garden and such that the tab members of each section correspond to particular flowers or plants. In such an application, visual decorating information may include the color associated with a particular flower found in the area of the garden.

In another embodiment, the home beautification journal may be used to plan, organize, and access information relating to the landscaping. For example, sections may correspond to areas of a yard and information regarding flowers, shrubs, trees, lawn, lawn decorations, stepping stones, and the like may suitably be included.

Although the foregoing text sets forth a detailed description of numerous different embodiments, it should be understood that the legal scope of this disclosure is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the following claims.

What is claimed is:

1. A home beautification journal comprising:
(a) a plurality of sections, each section corresponding to a household area, and each section containing at least one page, wherein the at least one page contains fields for entering information regarding home beautification projects;
(b) a plurality of tabs, each tab corresponding to a household area; and,
(c) a protective cover.

2. The home beautification journal according to claim 1 wherein the household area is selected from the group consisting of house exterior, garden, garage, porch, shed, house interior, kitchen, dining room, living room, family room, great room, bedroom, bathroom, utility room, pantry, and closet.

3. The home beautification journal according to claim 1 wherein the fields for entering information are selected from the group consisting of location, paint color, paint number, paint formula, paint brand, paint vendor, date of purchase, paint cost, date painted, painter's name, number of coats, brush/bristle type, roller/nap type, container number, primer information, surface area, amount of paint anticipated/consumed, job cost, carpet name, carpet brand, carpet type, carpet color, tile name, tile brand, tile type, tile color, tile pattern, linoleum name, linoleum brand, linoleum type, linoleum pattern, wood type, wood source, wood cost, stain cost, stain name, stain brand, stain type, stain color, brick name, brick brand, brick color, plaster name, plaster brand, plaster type, plaster color, bedding name, bedding source, fixture name, fixture brand, fixture type, fixture color, fixture source, fixture cost, furniture type, furniture color, furniture cost, drapery name, drapery brand, drapery type, drapery color, drapery source, drapery cost, and drapery pattern

4. The home beautification journal according to claim 1 wherein the at least one page comprises a page for entering information regarding wall treatments.

5. The home beautification journal according to claim 1 wherein the at least one page comprises a page for entering information regarding trim treatments.

6. The home beautification journal according to claim 1 wherein the at least one page comprises a page for entering information regarding ceiling treatments.

7. The home beautification journal according to claim 1 wherein the protective cover comprises a ringed binder which receives said plurality of sections and said plurality of tabs.

8. The home beautification journal according to claim 1 wherein the pages are fabricated from paper which is of at least about 90 pound index.

9. The home beautification journal according to claim 1 further comprising a pocket.

10. The home beautification journal according to claim 9 wherein the pocket is a cloth pouch.

11. The home beautification journal according to claim 1 further comprising a securing element.

12. The home beautification journal according to claim 1 further comprising a page marker.

13. The home beautification journal according to claim 1 wherein the plurality of tabs are layered.

14. The home beautification journal according to claim 1 wherein the pages include an area for recording visual decorating information.

15. The home beautification journal according to claim 1 wherein the pages include an area for application of a paint sample.

16. The home beautification journal according to claim 1 wherein the information regarding home beautification projects comprises information relating to painting projects.

17. A method for organizing and recording information regarding home beautification projects comprising:
(a) providing at least one page containing a room field, a surface field, and a surface treatment field;
(b) recording a room identifier in the room field;
(c) recording a surface identifier in the surface field; and,
(d) recording a surface treatment identifier in the surface treatment field.

18. The method of claim 17 further comprising providing a plurality of tabs corresponding to a household area to divide the one or more pages into sections corresponding to the household area.

19. The method of claim 17 wherein a second room identifier, a second surface identifier, and a second surface treatment identifier are recorded on a second page of the at least one page.

20. The method of claim 17 further comprising providing a tab member which is attached to the at least one page.

21. The method of claim 17 wherein a paint sample is applied to the tab member.
